(19) United States
(12) Patent Application Publication
(10) Pub. No.: US 2008/0059441 A1
(43) Pub. Date: Mar. 6, 2008

(54) SYSTEM AND METHOD FOR ENTERPRISE-WIDE DASHBOARD REPORTING

(75) Inventors: Mark Gaug, Vestal, NY (US); Nicholas T. Pascarelli, Endicott, NY (US)

Correspondence Address: BURNS & LEVINSON, LLP, 125 SUMMER STREET, BOSTON, MA, 02110, US

(73) Assignee: LOCKHEED MARTIN CORPORATION, Bethesda, MD (US)

(21) Appl. No.: 11/846,717

(22) Filed: Aug. 29, 2007

Related U.S. Application Data
(60) Provisional application No. 60/841,165, filed on Aug. 30, 2006.

(51) Int. Cl. G06F 17/30

(52) U.S. Cl. 707/4; 707/E17.014

(57) ABSTRACT

A system and method for presenting real-time enterprise data to a user, receiving selections from the user, and providing query results from multiple databases in real time to the user, where the databases may be accessible through disparate networks and the Internet.

### CROSS REFERENCE TO RELATED APPLICATIONS

This application claims priority under 35 U.S.C. § 119 from provisional application Ser. # 60/841,165 entitled SYSTEM AND METHOD FOR ENTERPRISE-WIDE DASHBOARD REPORTING, filed on Aug. 30, 2006, incorporated by reference herein.

### BACKGROUND

In a typical enterprise dashboard system, data from many sources must be displayed in a dashboard format that typically includes many different textual, table, and chart areas designed to show key performance indicators and the general health of the enterprise in a quick glance. Typically, for real time information databases to be presented in dashboard format, data marts or data warehouses are required to avoid having to query real time transaction processing databases. Queries against transaction processing databases can interfere with gathering data, especially when end users can do ad hoc queries. Also, transaction processing databases typically do not have indices and other facilities that enable real time queries. The term “data mart” is used herein to refer to a snapshot of operational data that can be used for, for example, business planning based upon analyses of past trends and experiences. The creation of a data mart is predicated on a specific, predefined need for a certain grouping and configuration of select data. The term “data warehouse” is defined herein to be a combination of databases across an entire enterprise, although it is not a combination of data marts. It is not always desired or possible to exclusively use the data mart/data warehouse solution for presenting real-time information because, typically, high costs are involved in setting up the hardware, software, security, maintenance and functionality associated with a data mart or data warehouse especially in an environment that spans multiple databases in multiple locations, such as the United States Postal Service (USPS).

A postal distribution center presents a unique and challenging data gathering environment. An enterprise information system must access, process, filter, and aggregate data from approximately 13,000 individual mail processing equipment (MPE) 39 (FIG. 1) and mail handling equipment (MHE) located in three hundred processing and distribution centers 10A (FIG. 1), twenty-five bulk mail centers 10B (FIG. 1), and numerous Associated Offices 10C (FIG. 1), in addition to several databases located throughout the enterprise. Processing of these data is typically done by segregated MPE 39 (FIG. 1) and MHE. The data themselves typically reside in many different formats and enter the system from a variety of locations including relational databases 17A (FIG. 1), flat files 18 (FIG. 1), and real time data sources 53 (FIG. 3).

### SUMMARY

In one embodiment, the system and method of the present disclosure can receive dashboard requests, query multiple disparate databases in multiple formats, merge the query results, and update the dashboard with the results in substantially real-time. For a better understanding of the present disclosure, reference is made to the accompanying drawings and detailed description.

### DESCRIPTION OF THE SEVERAL VIEWS OF THE DRAWING

FIG. 1 is a schematic block diagram of the environment of the system of the present disclosure for real time enterprise dashboard reporting;

FIG. 2 is a schematic block diagram of the system of the present disclosure;

FIG. 3, is a schematic block diagram of the details of the interface or interface tier application of the present disclosure;

FIG. 4 is a flowchart of a first illustrative method of the present disclosure; and

FIG. 5 is a flowchart of a second illustrative method of the present disclosure.

### DETAILED DESCRIPTION OF THE DISCLOSURE

The present system is now described more fully hereinafter with reference to the accompanying drawings, in which the illustrative embodiment of the present disclosure is shown. The following configuration description is presented for illustrative purposes only. Any computer configuration satisfying the speed and interface requirements herein described may be suitable for implementing the system of the present disclosure.

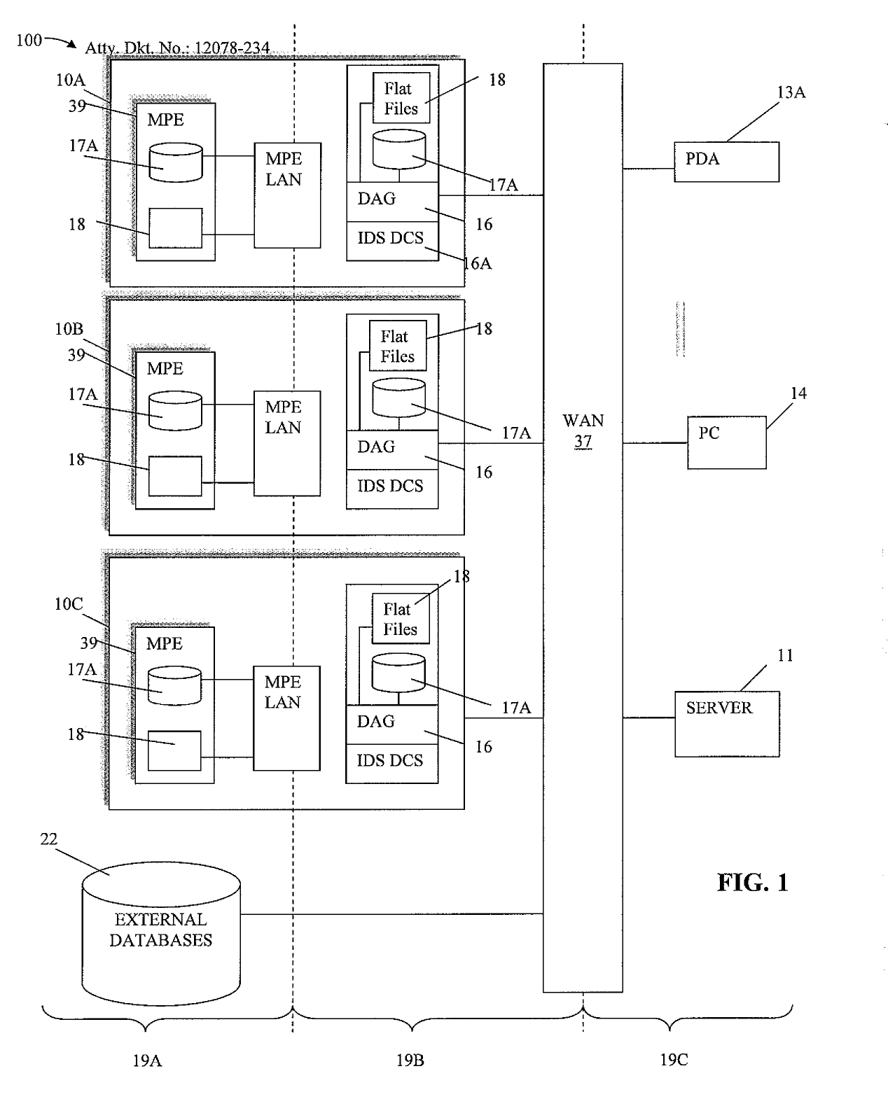

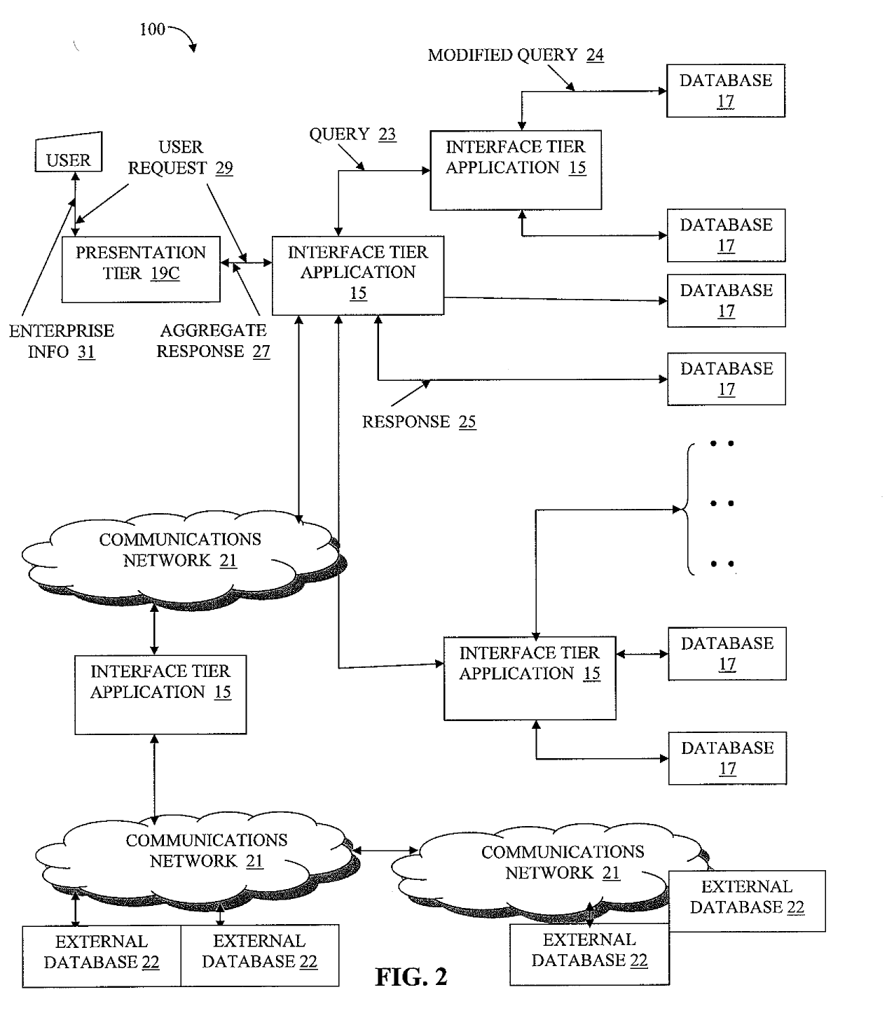

Referring now primarily to FIG. 1, enterprise management system 100 can include, but is not limited to including, a conventional presentation tier 19C, an interface tier application 15 (FIG. 2), in interface tier 19B, such as, for example, data access gateway DAG 16, having the capabilities described herein and further capabilities, and conventional transaction processing databases in data tier 19A. Note that the terms interface tier 19B and middle tier 19B are used interchangeably throughout this specification. System 100 can provide for configuring conventional presentation tier 19C, for example a dashboard application, to interface with interface tier application 15 and can provide for configuring interface tier application 15 to query conventional multi-location transaction processing relational databases 17A and flat files 18 in real time. Interface tier application 15 can be configured to, but is not limited to being configured to, (1) control which queries are run so as to avoid interfering with data gathering, (2) cache results so multiple queries for the same data do not result in multiple trips to the database, (3) allow parallel multi-site and multi-network queries, and (4) allow isolated network areas to be reachable. DAG 16, illustratively described in U.S. patent application Ser. # 11/449,753, filed on Jun. 9, 2006, entitled INFORMATION ROUTING IN A DISTRIBUTED ENVIRONMENT, and incorporated herein in its entirety by reference, can provide the listed capabilities. System 100 can provide an improved interface tier application 15 that can allow for replacing the exclusive need for querying a data warehouse or data mart directly by leveraging transaction processing databases that have existing processing power necessary for real time queries, for example, mail processing facility databases.

Continuing to refer to FIG. 1, interface tier 19B can be configured to (a) analyze query 23 to determine a plurality of databases 17 to satisfy query 23; (b) separate plurality of databases 17 into fast query transactional databases and slow query databases, wherein fast query databases can respond to query 23 in less than or equal to a preselected timeframe, and wherein slow query databases are datamarts and data warehouses that contain reformatted or aggregated data from transactional databases which response to query 23 directly from the transactional databases would return in greater than the preselected timeframe; (c) initiate query 23 to the fast query databases; (d) select the data marts or the data warehouses having data from the slow query databases; (e) initiate query 23 to the selected data marts or data warehouses; (f) receive fast query response from the fast query databases; (g) receive slow query responses from the selected data marts or the selected data warehouses; (h) aggregate the fast query responses and the slow query responses into aggregated response 27; and (i) provide aggregated response 27 for display to a client computer. System 100 can further include presentation tier 19C configured to receive user requests 29, formulate queries 23 based on user requests 29, receive aggregated response 27 from interface tier 19B, format aggregated response 27 into enterprise information 31, and update enterprise information 31 to the computer, for example, the client computer in substantially real-time. “Substantially real-time” is defined herein to mean that enterprise information 31 is updated to the computer in as close to real-time as possible, given a standard computer configuration and standard communication delays. System 100 can optionally be configured such that presentation tier 19C is in dashboard format, and that enterprise information 31 includes key performance indicators of an enterprise, so that presentation tier 19C presents enterprise information 31 in a plurality of formats including textual, table, and chart formats. System 100 can be further optionally configured such that plurality of databases 17 includes transaction data or aggregated transaction data, that at least one of plurality of databases 17 is electronically coupled to another of plurality of databases 17 by at least one communications network 21, and that aggregated response 27 is in on-line analytical processing (OLAP) format. System 100 can be even still further optionally configured such that presentation tier 19C is configured to allow a user to directly query plurality of databases 17, query 23 is configured to instruct a plurality of interface tier applications 15 to create a plurality of queries 23 against plurality of databases 17, and interface tier 19B is further configured to automatically configure the datamarts and data warehouses for future queries if the slow query responses are null.

Continuing to still further refer to FIG. 1, system (100) can be further optionally configured such that said presentation tier 19C includes a service requestor node that is individually network addressable; interface tier 19B includes a monitoring node that is individually network addressable, disposed in a tiered network arrangement, and coupled to service requestor node by a communications network 21; data tier 19A includes a service provider node that is individually network addressable, disposed in a tiered network arrangement including presentation tier 19C, interface tier 19B, and data tier 19A, coupled to monitoring node by communications network 21 and coupled to interface tier 19B; the service provider node is configured to provide a service through communications network 21 in response to query 23; query 23 includes a message header, having a list of destination nodes, including one of the service provider nodes to which query 23 is addressed, and query language; a routing module is disposed in the monitoring node and configured to analyze the list of destination nodes in query 23, the routing module creating modified query 24 including at least one child node selected from plurality of databases 17 based on a fan-out of communications network 21, and wherein routing module forwards modified query 24 to at least one child node, modified query 24 includes a message header, having an updated list of one or more destination nodes, including one of the service provider nodes, to which modified query 24 is addressed, and the query language; and the routing module is configured to receive response 25 to said query 23 from the at least one child node, aggregate response 25 received into an aggregate response 27, and send aggregate response 27 to a parent node in communications network 21. The tiered network arrangement is optionally dynamically configured. Further, query 23 can optionally include extensible mark-up language, simple object access protocol. Plurality of databases 17 can optionally include a web service.

With even still further reference primarily to FIG. 1, each MPE/MHE 39 has its own data formats including data names, data types, refresh cycles, persistency, and definitions of terms, which can make queries complex. For example, to determine the percent time MPE 39 is operational, a typical structured query language (SQL) query string length to collect, format, and aggregate for reporting for this statistic is about 2500 characters. To develop the drill-down displays in a dashboard application, there are typically many different queries necessary. Since each MPE 39 or MHE is unique, each could have a unique implementation for each query 23 (FIG. 2), which could create the potential for hundreds of complex queries necessary for a simple drill-down dashboard application. Conventional IDS DCS 16A and DAG 16 components can be used and can reference conventional data, in, for example, relational databases 17A and flat files 18, on individual MPE 39 or MHE and on IDS DCS 16A. External databases 22 (FIG. 2) located on, for example, surface visibility and attendance databases available from WAN 37 can also be referenced.

Referring now to FIG. 2, system 100 can be further configured to configure interface tier application 15 to query transaction processing databases if the transaction processing databases can return results in a timely manner to the dashboard application, thus avoiding the expense of setting up data warehouses/data marts that are not necessary. Interface tier application 15 can also be configured to query other interface tier applications 15 and data marts/warehouses, where all queries can proceed in parallel. Advantageously, the system and method of the present disclosure can allow users to drill down using web based conventional dashboard applications that show key performance indicators and identify potential problems in a dynamic real time display.

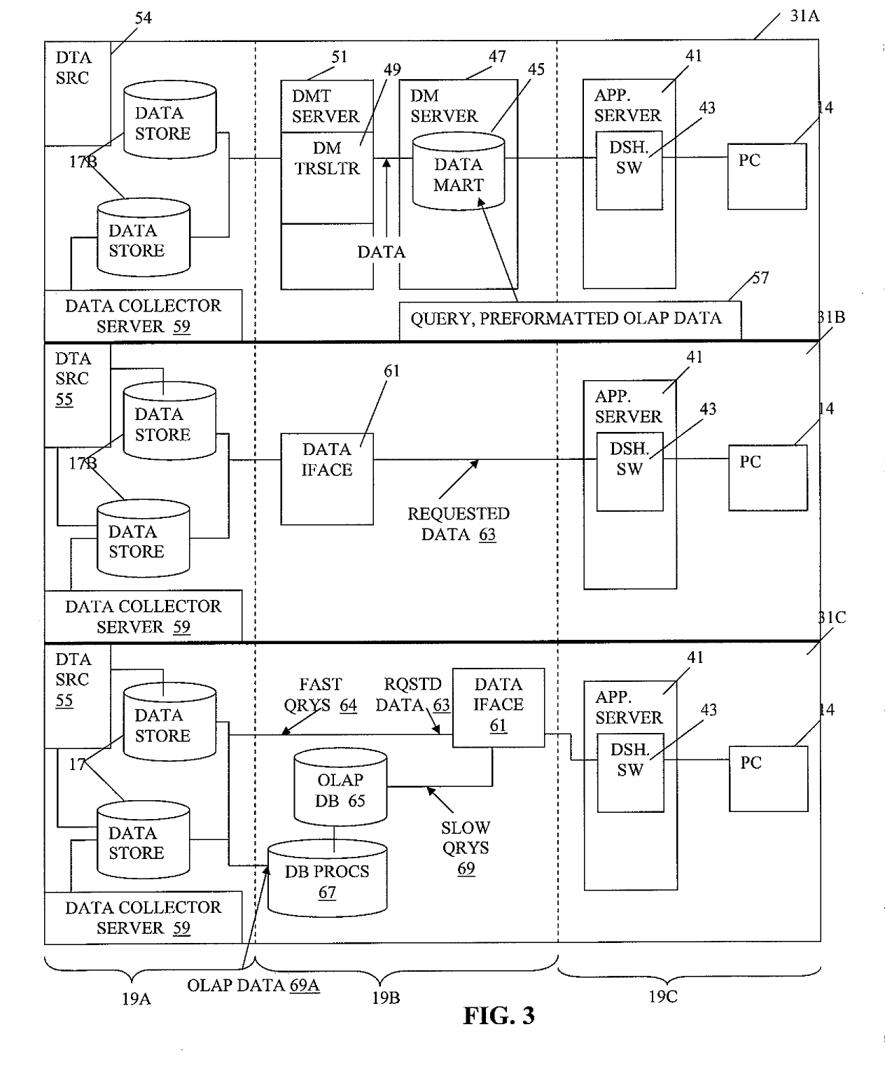

Continuing to refer primarily to FIG. 2, system 100 can include, but is not limited to, (1) presentation tier 19C configured to generate a dashboard display on a client computer (by either being present on the client computer, such as, for example, personal computer (PC) 14 or personal data assistant (PDA) 13A (FIG. 1), or by being present on server 11 and serving up the display on the client computer through an interface such as a web page, (2) interface tier application 15 in interface tier 19B, for example data access gateway (DAG) 16 (FIG. 1), configured to (a) receive user request 29 from the client computer, (b) send response 25 to the client computer, (c) compose queries 23 from the user request 29, the number and types of queries depending on which data sources are required to service the user requests 29, (d) provide the queries 23 to databases 17, (e) receive responses 25 to queries 23, (f) aggregate responses 25, and (g) provide responses 25 to presentation tier 19A, and (3) databases 17 in data tier 19A configured to receive and respond to queries 23 from interface tier application 15, particular real time data sources 53 (FIG. 3) depending upon the number and types of queries 23 composed by interface tier application 15. In one embodiment, presentation tier 19A is in dashboard format, enterprise information 31 includes key performance indicators of an enterprise, and presentation tier 19A presents enterprise information 31 in a variety of formats including textual, table, and chart formats.

Continuing to still further refer to FIG. 2, interface tier application 15 can aggregate the query responses to produce aggregate response 27 for a client computer such as, for example, PDA 13A (FIG. 1) or PC 14 (FIG. 1), that satisfies user request 29. The client display software can display aggregate response 27 at the client computer in a dashboard format that can illustratively include textual, table and chart areas that can show, for example, key performance indicators and the general health of the enterprise. Database 17 can include, but is not limited to, transaction data and aggregated transaction data originating, for example, from MPE 39 (FIG. 1). These data could, for example, be time and attendance data or aggregated time and attendance data. Database 17 could also be a data mart or data warehouse consisting of data already aggregated from different data sources. Multiple databases 17 could also be connected by networks such as the Internet that allows multiple disparate protocols to interoperate. Multiple interface tier applications 15 can be used to route queries 23 to and from database 17. In general, the term “database 17” used herein refers to any type of database that can include, but is not limited to, a data mart, a data warehouse, a flat file, a storage network, transactional data, aggregated transactional data, and a relational database. The query responses 25 can be provided by interface tier application 15 in multi-dimensional or on-line analytical processing (OLAP) format, a format that can be used in dashboard or pivot tables allowing the user to directly query the data returned without repeated requests for additional information. Further, interface tier application 15 can allow independent queries 23 to many independent databases 17 if multiple interface tier applications 15 are organized in a tree-like structure. For example, one aggregate response 27 can flow from ten interface tier applications 15, and each of these interface tier applications 15 can receive aggregate responses 27 from ten other interface tier applications 15 to make a network capable of aggregating one thousand interface tier applications 15.

Continuing to refer to FIG. 2, in the illustrative embodiment, databases 17 can include transaction data or aggregated transaction data, and can be data marts or data warehouses that include data aggregated from databases 17. Further, databases 17, in one embodiment, can be electronically coupled by communications networks 21 and the Internet. Communications networks 21 can be disparate networks, i.e. separated physically, logically, or otherwise from each other, and optionally operating under various and different protocols. Interface tier application 15 can act as a data as well as protocol gateway, and can further allow information to pass through a firewall because it can operate like a browser. For example, a hub node physically located in Washington D.C. can initiate a data request that would be routed through interface tier application 15 to a hub node physically located in San Francisco, and which could further be required to access a database connected to a private network accessible to the hub in San Francisco, but not to the hub in Washington D.C. Still further, aggregate response 27 can be provided in on-line analytical processing (OLAP) format, and can allow a user to directly query databases 17. In one embodiment, a plurality of interface tier applications 15 can create, as a result of a single user request 29, a plurality of queries 23 and use them to query databases 17.

With still further reference to FIG. 2, in one embodiment, presentation tier 19A can be a service requestor node that is individually network addressable, and interface tier application 15 can be a monitoring node that is individually network addressable, disposed in a tiered network arrangement, and coupled to the service requester node via a communications network 21. In one embodiment, the database 17 can be a service provider node that is individually network addressable, disposed in the tiered network arrangement, and coupled to the monitoring node via communications network 21, and the service provider node can be configured to provide a service via communications network 21 in response to query 23. Further, in one embodiment, query 23 can include a message header, having a list of destination nodes, including one of the service provider nodes to which query 23 is addressed, and query language. Still further, in one embodiment, a routing module can be disposed in the monitoring nodes and configured to analyze the list of destination nodes in query 23, and the routing module can create a modified query including a child node selected from database 17 based on a fan-out of communications network 21, where the routing module can forward the modified query to the child node, and where the modified query can include a message header, having an updated list of one or more destination nodes, including one of the service provider nodes, to which the modified query is addressed, and the query language. Even still further, in one embodiment, the routing module can be configured to receive responses 25 to query 23 from the child node, can aggregate responses 25 into an aggregate response 27, and can send aggregate response 27 to a parent node in communications network 21. Optionally, query 23 can include extensible mark-up language and/or simple object access protocol. Further optionally, database 17 can be a web service, and the tiered network arrangement can be dynamically configured.

Referring now to FIG. 3, interface tier application 15 can include logic to access, filter, aggregate, and possibly store data so it is in ready-to-display format. Interface tier application 15 can be a hybrid 31C of two conventional methodologies: (1) conventional data mart access application 31A, and (2) conventional Online Transaction Processing (OLTP) application 31B. Conventional data mart application 31A, executing on data collector server 59, queries the data from native locations such as, for example, real time data sources 53, on a periodic basis and stages the query results in temporary databases, such as data store 17B. Data mart databases are created, possibly filtered by data mart translator 49 executing on data mart translator server 51, and optimized with respect to the type of data reporting they implement by, for example, data mart server 47, and stored in data mart 45, for example, in a preformatted structure. This is particularly advantageous when setting up dashboards, since these implementations involve data table structure formats, referred to as On Line Analytical Processing (OLAP), optimized to be queried, for example by query 57, and filtered directly by the dashboard user. Data marts are typically used for web reporting when query results cannot be returned within an attention span of a web browser user, for example, thirty seconds. Data mart or data warehouse application 31A can require more resources than OLTP applications 31B, and also can increase network traffic, because of the necessity to move data from the local data stores 17B to the data mart 45 or data warehouse. Data marts can be implemented with triggers and stored procedures within a database, for example, an ORACLE® database, or can rely on external products to extract the data and move it to the data mart. Dashboard software 43, executing on applications server 41, can provide query results to PC 14.

Continuing to refer to FIG. 3, OLTP application 31B can directly query local data. For this approach to be successful, data from all distributed sites are be queried, filtered, aggregated, formatted and displayed in the browser within an amount of time that is similar to the attention span of the browser user, for example, thirty to forty-five seconds. Conventional OLTP system 31B can query large numbers of sites and rapidly return the aggregated results. Data collector server 59 can gather requested data 63 from data source 55. Requested data 63 can be temporarily stored in data store 17B, and can be filtered through data interface 61.

Continuing to still further refer to FIG. 3, system 100 can include the desirable capabilities of both conventional data mart access application 31A, and conventional Online Transaction Processing (OLTP) 31B, and capabilities unique to system 100, including, but not limited to (1) data gathering, aggregation, filtering from multiple types of geographically diverse data sources and returning results to on-line reporting systems, (2) ability to use virtually any type data source 55, either database, flat file or real time data sources, (3) data caching in memory for multiple users to query the same data without repeated traversals to the data source, (4) ability to allow new queries and data sources 55 to be added to data interface 61 with only the change of configuration files, (5) ability to allow the addition of new types and technologies of input data sources using a plug-in data link library, (6) querying and aggregation data from many facilities using the combined processing power of many servers, (7) ability to query data sources on different LANs and to provide results to clients on any of the LANs without IP address mapping, and (8) ability to batch process large data sets. Since setting up data marts and/or data warehouses for all dashboard data transactions could be very expensive and unnecessary, for data that can be queried in real time, aggregated, formatted into OLAP data 69A, and returned to a browser within the preselected timeframe that can coincide with, for example, a normal wait time of thirty seconds, system 100 can configure interface tier application 15 to perform real time querying of the underlying data sources 55. Additionally, for data that, because of its query complexity, cannot be returned within the preselected timeframe, system 100 can configure interface tier application 15 to establish a data mart In the illustrative embodiment, a data warehouse may not be needed to consolidate all for a “global view” because interface tier application 15 can query sites and return the aggregate results from a query of data marts using, for example, stored database procedures 67. Database procedures 67 can, for example, be initiated by a timer to happen periodically or during periods of low processing, or can be triggered by data arrival. System 100 can also include a database schema and configuration files. In this configuration, “slow” queries 69 can be served by OLAP database 65, whereas “fast” queries 64 can be served by data store 17B, and all query results can be provided to dashboard software 43 through data interface 61.

Continuing to even still further refer to FIG. 3, presentation tier 19A can include, but is not limited to including, the capabilities of receiving input from interface tier application 15 presenting a dashboard to a client computer that can include input from interface tier application 15, receiving input from the client computer, and providing the input to interface tier application 15. Presentation tier 19 can be a conventional application such as, for example, COGNOS® Business Reporting, HYPERION REPORTING®, ORACLE® Business Intelligence, Information Builders, WEBFOCUS® Business Intelligence Dashboard, CORDA® Centerview, or simply an amalgamation of products available from, for example, MICROSOFT®, having the following attributes: (1) ability to execute in the context of a browser, (2) ability to display key process indicators (KPI) information in a graphical format, (3) ability to drill down, and (4) ability for data to be refreshed in real time from multiple data sources.

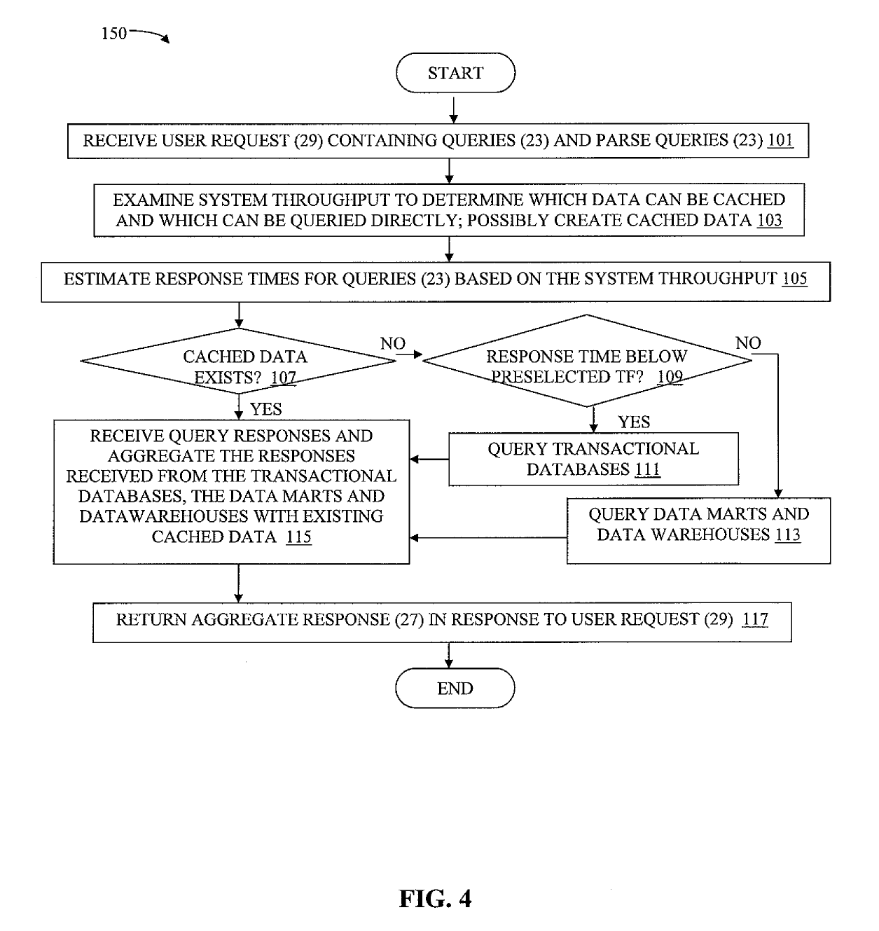

Referring now primarily to FIG. 4, method 150 of the present disclosure can include, but is not limited to including, the steps of receiving 101 user request 29 (FIG. 2) containing query 23 (FIG. 2) and parsing query 23 (FIG. 2); examining 103 system throughput to determine which data can be cached and which can be queried; possibly creating cached data based on if the data can be cached; estimating 105 response times for query 23 (FIG. 2) based on said the system throughput. If 105 cached data does not exist, and if 107 response time is below a preselected timeframe, method 150 can further include the step of querying 109 transactional databases. If 105 cached data does not exist, and if 107 response time is not below a preselected timeframe, method 150 can further include the step of querying 113 data marts and data warehouses. If 105 cached data exists, method 150 can include the step of receiving 115 query responses and aggregating the responses received from the transactional databases, the data marts and the data warehouses with the cached data. Method 150 can also include the step of returning 117 the aggregated response to the requester.

Method 150 can optionally include the steps of designing an architecture to allow network and data source access, defining key process indicators and graphics displays to meet the accessibility requirements of Section 508 in accordance with Federal Acquisition Circular 97-27, analyzing underlying data structures to determine data formatting, querying and aggregation, backing up the system data stores, and developing the dashboard displays.

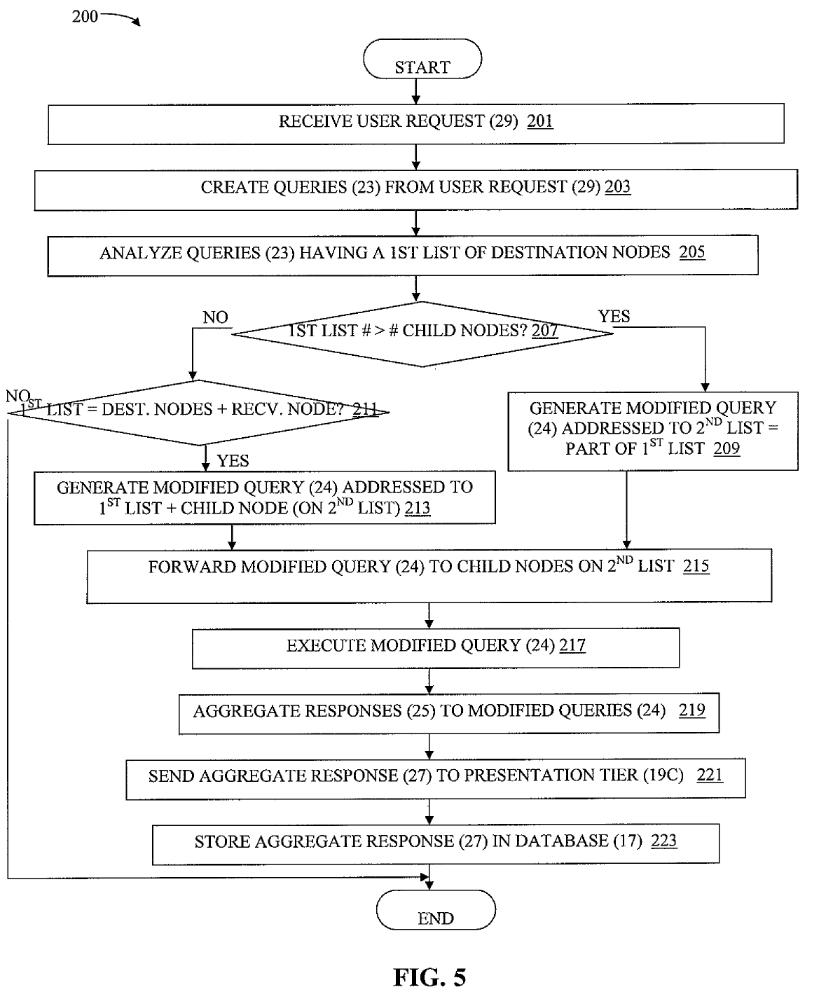

Referring now primarily to FIG. 5, method 200 for providing enterprise management can include, but is not limited to, the steps of receiving 201 user request 29 (FIG. 2), creating 203 query 23 (FIG. 2) from user request 29 (FIG. 2), and analyzing 205 query 23 (FIG. 2), where query 23 can include a header having a first list of destination nodes to which query 23 is addressed and can include query language. If 207 the first list represents a number of destination nodes greater than a number of child nodes in a fan-out, method 200 can further include the step of generating 209 modified queries 24 (FIG. 2) corresponding to the number of child nodes in the fan-out and including a second list of destination nodes representing a portion of the first list of destination nodes, modified queries 24 (FIG. 2) being addressed to a destination node in the second list of child nodes to which modified queries 24 (FIG. 2) are addressed. Otherwise, if 211 the first list contains destination nodes in addition to the receiving node, method 200 can include the steps of generating 213 modified queries 24 (FIG. 2) corresponding to the number of destination nodes in the first list and including a second list of destination nodes representing a child node to which the modified queries 24 (FIG. 2) are addressed. Method 200 can still further include the steps of forwarding 215 the modified queries 24 (FIG. 2), if any, to child nodes on the second list, acting 217 on the query language, waiting for a response 25 (FIG. 2) from each child node in the fan-out where modified queries 24 (FIG. 2) have been forwarded, aggregating 219 responses from child nodes, and forwarding 221 aggregate responses 27 (FIG. 2) to presentation tier 19A (FIG. 2). Method 200 can optionally include the step of aggregating 223 responses 25 (FIG. 2) into database 17 (FIG. 2).

Methods 150 (FIG. 4) and 200 (FIG. 5) can be, in whole or in part, implemented electronically. Signals representing actions taken by elements of system 100 (FIG. 1) can travel over electronic communications media and from node to node in communications network 21 (FIG. 2). Control and data information can be electronically executed and stored on computer-readable media. Methods 150 and 200 can be implemented to execute on a node in computer communications network 21 (FIG. 2). Common forms of computer-readable media include, but are not limited to, for example, a floppy disk, a flexible disk, a hard disk, magnetic tape, or any other magnetic medium, a CDROM or any other optical medium, punched cards, paper tape, or any other physical medium with patterns of holes, a RAM, a PROM, and EPROM, a FLASH-EPROM, or any other memory chip or cartridge, a carrier wave, electronic signal, or any other medium from which a computer can read.

Although the disclosure has been described with respect to various embodiments, it should be realized this disclosure is also capable of a wide variety of further and other embodiments.

What is claimed is:

1. An enterprise management system comprising:
an interface tier configured to
(a) analyze queries to provide a plurality of databases to satisfy said queries;
(b) separate said plurality of databases into fast query transactional databases and slow query databases, wherein said fast query databases can respond to said queries in less than or equal to a preselected timeframe, and wherein said slow query databases are datamarts and data warehouses that contain reformatted or aggregated data from transactional databases in which a response to said queries directly from said transactional databases would return in greater than said preselected timeframe;
(c) initiate said queries to said fast query databases;
(d) select said data marts or said data warehouses having data from said slow query databases;
(e) initiate said queries to the selected data marts or the selected data warehouses;
(f) receive fast query responses from said fast query databases;
(g) receive slow query responses from the selected data marts or the selected data warehouses;
(h) aggregate said fast query responses and said slow query responses into an aggregate response; and
(i) provide said aggregate response for display to a computer; and
a presentation tier configured to receive user requests, formulate said queries based on said user requests, receive said aggregated response from said interface tier, format said aggregated response into enterprise information, and update said enterprise information to said computer in substantially real-time.

2. The system of claim 1 wherein said presentation tier is in dashboard format.

3. The system of claim 1 wherein said enterprise information includes key performance indicators of an enterprise, and wherein said presentation tier presents said enterprise information in a plurality of formats including textual, table, and chart formats.

4. The system of claim 1 wherein said plurality of databases includes transaction data or aggregated transaction data.

5. The system of claim 1 wherein at least one of said plurality of databases is electronically coupled to another of said plurality of databases by at least one communications network.

6. The system of claim 1 wherein said aggregate response is in on-line analytical processing (OLAP) format.

7. The system of claim 1 wherein said presentation tier is configured to allow a user to directly query said plurality of databases.

8. The system of claim 1 wherein said queries are configured to instruct a plurality of interface tier applications to create a plurality of said queries against said plurality of databases.

9. The system of claim 1 wherein said interface tier is further configured to automatically configure the datamarts and data warehouses for future queries if said slow query responses are null.

10. The system of claim 1
wherein said presentation tier includes a service requestor node that is individually network addressable;
wherein said interface tier includes a monitoring node that is individually network addressable, disposed in a tiered network arrangement, and coupled to said service requester node by a communications network;
wherein a data tier includes a service provider node that is individually network addressable, disposed in said tiered network arrangement including said presentation tier, said interface tier, and said data tier, coupled to said monitoring node by said communications network, and coupled to said interface tier;
wherein said service provider node is configured to provide a service through said communications network in response to said queries;
wherein said queries include message headers, having lists of destination nodes, including one of said service provider nodes to which said queries are addressed, and query language;
wherein a routing module is disposed in said monitoring node and configured to analyze said lists of destination nodes in said queries, said routing module creating modified queries including at least one child node selected from said plurality of databases based on a fan-out of said communications network, and wherein said routing module forwards said modified queries to said at least one child node, wherein said modified queries include message headers, having updated lists of one or more destination nodes, including one of said service provider nodes, to which said modified queries are addressed, and the query language; and
wherein said routing module is configured to receive a response to said queries from the at least one child node, aggregate said response received into said aggregate response, and send said aggregate response to a parent node in said communications network.

11. The system of claim 10 wherein said tiered network arrangement is dynamically configured.

12. The system of claim 1 wherein said queries include extensible mark-up language.

13. The system of claim 1 wherein said queries include simple object access protocol.

14. The system of claim 1 wherein said plurality of databases includes a web service.

15. A method for updating a dashboard in substantially real-time comprising the steps of:
(a) analyzing queries to provide a plurality of databases to satisfy the queries;
(b) separating the plurality of databases into fast query transactional databases and slow query databases, wherein the fast query databases respond to the queries in less than or equal to a preselected timeframe, and wherein the slow query databases are datamarts and data warehouses that contain reformatted or aggregated data from transactional databases in which a response to the query directly from said transactional databases would return in greater than the preselected timeframe;
(c) initiating the queries to the fast query databases;
(d) selecting the data marts or the data warehouses for the slow query databases;
(e) initiating the queries to the selected data marts or data warehouses;
(f) receiving fast query responses from the fast query databases;
(g) receiving slow query responses from the selected data marts or data warehouses;
(h) aggregating the fast query responses and the slow query responses into an aggregate response; and
(i) providing the aggregate response to a presentation tier for display to a computer.

16. The method of claim 15 further comprising the steps of:
creating an interface tier configured to perform steps (a) through (i);
configuring the interface tier to access the plurality of databases from a communications network; and
configuring the interface tier to include a firewall.

17. The method of claim 15 further comprising the steps of:
configuring the interface tier to access private networks and public networks.

18. A method for providing enterprise management comprising the steps of:
receiving a user request;
creating queries from the user request;
analyzing queries, wherein a message including the queries includes first list of one or more destination nodes to which the queries are addressed and query language;
if the first list represents a number of destination nodes greater than a number of child nodes in a fan-out, generating at least one modified query corresponding to the number of child nodes in the fan-out and including a second list of one or more child nodes, the second list of destination nodes representing a portion of the first list of destination nodes, the at least one modified query being addressed to a destination node in the second list of destination nodes to which the at least one modified query is addressed;
otherwise, if the first list contains one or more destination nodes in addition to the receiving node, generating the at least one modified query corresponding to the number of destination nodes in the first list and including a second list of at least one child node, the second list of destination nodes representing a child node to which the at least one modified query is addressed;
forwarding the at least one modified query, if any, to child nodes on the second list;
executing the at least one modified query;
aggregating responses from child nodes into an aggregate response; and
forwarding the aggregate response to a presentation tier.

19. The method of claim 18 wherein the destinations nodes and the child nodes are dynamically configured in a tiered network arrangement.

20. A communications network comprising at least one node for carrying out the method according to claim 15.

21 A computer data signal embodied in electromagnetic signals traveling over a communications network carrying information capable of causing a computer system in the communications network to practice the method of claim 15.

22. A computer readable medium having instructions embodied therein for the practice of the method of claim 15.
